(19) United States
(12) Patent Application Publication
(10) Pub. No.: US 2026/0336142 A1
(43) Pub. Date: Oct. 29, 2026

(54) VISUAL ELECTRIC HAIR CUTTER DRIVEN BY EXTERNAL-ROTOR MOTOR

(71) Applicant: NINGBO ICLIPPER ELECTRIC APPLIANCE CO.,LTD, Ningbo (CN)

(72) Inventor: Haoze WU, Ningbo (CN)

(21) Appl. No.: 19/235,662

(22) Filed: Jun. 12, 2025

(30) Foreign Application Priority Data
Apr. 28, 2025 (CN) 202520828618.0

(51) Int. Cl. B26B 19/28; B26B 19/06; H02K 7/075

(52) U.S. Cl. CPC B26B 19/28; B26B 19/06; H02K 7/075

(57) ABSTRACT

A visual electric hair cutter driven by an external-rotor motor comprises a housing, a cutter head assembly, an external-rotor motor; the cutter head assembly is arranged at a front end of the housing, and the external-rotor motor is arranged within the housing; the housing is at least partially provided with a window for observing the external-rotor motor; an output shaft of the external-rotor motor is provided with an eccentric wheel, the eccentric wheel is provided with an eccentric shaft, and the eccentric shaft is sleeved with a bearing; the movable cutter holder of the cutter head assembly is provided with a transmission groove, and the bearing extends into the transmission groove; through the interaction between the bearing and the transmission groove, the eccentric wheel is in transmission connection with the movable cutter holder; the present invention has a simple structure and is capable of satisfying the user needs.

### TECHNICAL FIELD

This invention generally relates to the technical field of hair tools, and more particularly, to a visual electric hair cutter driven by an external-rotor motor.

### BACKGROUND

An electric hair cutter is a common tool for cutting human or animal hair, which normally includes a housing, a cutter head assembly mounted at the front end of the housing, a driving motor, a power supply assembly and a control circuit board arranged in the housing. The driving motor propels a movable blade of the cutter head assembly at the front end to transversely reciprocate through a transmission assembly, thereby interacting with a fixed blade of the cutter head assembly such that the hair cutting is realized.

Conventional electric hair cutters normally adopt an internal-rotor motor as a driving motor. With the progress of the hairdressing tool industry, electric hair cutters driven by the external-rotor motor have appeared. Compared with an internal-rotor motor, the small-sized external-rotor motor realizes the output of large torque while meeting the requirement of shearing force of a shearing end at a lower rotating speed. Therefore, electric hair cutters driven by the external-rotor motor have gradually become popular.

However, conventional electric hair cutters driven by the external-rotor motor sold on the market have the following shortcomings: first, when in use, the operation condition of the external-rotor motor cannot be observed; under such circumstances, when the motor gets stuck or blocked due to the cut hair entering the electric hair cutter, the user cannot turn off the electric hair cutter in time, resulting in the failure of the electric hair cutter or even damage to the motor; second, a swing rod is arranged inside the housing, and the external-rotor motor is in transmission connection with the cutter head assembly by means of the swing rod, leading to complex internal structure of the electric hair cutter and high manufacturing cost.

Therefore, it is urgent for those skilled in the art to solve the prior problems.

### SUMMARY

The purpose of the present invention is to provide a visual electric hair cutter driven by an external-rotor motor, which has a simple structure and is capable of satisfying the user needs.

To achieve the above purpose, the present invention adopts the following technical solution: a visual electric hair cutter driven by an external-rotor motor comprises a housing, a cutter head assembly and an external-rotor motor; the cutter head assembly is arranged at a front end of the housing, and the external-rotor motor is arranged within the housing; the housing is at least partially provided with a window for observing the external-rotor motor; an output shaft of the external-rotor motor is provided with an eccentric wheel, the eccentric wheel is provided with an eccentric shaft, and the eccentric shaft is sleeved with a bearing; the movable cutter holder of the cutter head assembly is provided with a transmission groove, and the bearing extends into the transmission groove; through the interaction between the bearing and the transmission groove, the eccentric wheel is in transmission connection with the movable cutter holder.

In another preferred embodiment, the window is arranged on an upper surface of the housing.

In another preferred embodiment, an outer wall of the rotor of the external-rotor motor is provided with a pattern. When the rotor rotates, the pattern rotating synchronously with the rotor can be observed through the window.

In another preferred embodiment, the movable cutter holder is provided with a convex platform, and the transmission groove is formed in the convex platform.

In another preferred embodiment, an outer wall of the bearing is in interference fit with the walls of the two sides of the transmission groove.

In another preferred embodiment, a motor fixing frame is arranged at the front end of the external-rotor motor, a mounting bracket corresponding to the motor fixing frame is arranged in the housing, and the motor fixing frame is fixedly connected to the mounting bracket.

In another preferred embodiment, the mounting bracket is provided with an avoidance hole for allowing the output shaft of the external-rotor motor to pass through.

In another preferred embodiment, the avoidance hole is provided with a sealing ring sleeved outside the output shaft of the external-rotor motor.

In another preferred embodiment, the eccentric wheel is eccentrically connected to the output shaft of the external-rotor motor.

In another preferred embodiment, an end portion of the eccentric shaft is provided with a snap spring for interacting with the bearing in a limiting manner.

Compared with the prior art, the present invention has the following advantages: the present invention provides a visual electric hair cutter driven by an external-rotor motor; through the arrangement of the window, when in use, the user may observe the operation of the external-rotor motor at any time through the window, so that convenient observation of the operating state of the external-rotor motor and better use experience are achieved; when the motor gets stuck or blocked due to the cut hair entering the interior of the electric hair cutter, the user may timely accurately operates (such as turn-off), which not only facilitates the normal operation of the electric hair cutter, but also prevents the motor from being damaged due to the long-term failure; thus, the user’s actual needs are satisfied sufficiently;

Moreover, the eccentric wheel is arranged on the output shaft of the external-rotor motor, the eccentric shaft of the eccentric wheel is sleeved with the bearing, and the movable cutter holder of the cutter head assembly is provided with the transmission groove for interacting with the bearing; through the interaction between the bearing and the transmission groove, the eccentric wheel is in transmission connection with the movable cutter holder; the aforesaid transmission structure achieves stable and reliable operating performance; moreover, it is unnecessary to use a conventional swing rod, so that the structure becomes simpler and the manufacturing cost is reduced.

### BRIEF DESCRIPTION OF THE DRAWINGS

FIG. 1 is a schematic diagram illustrating an overall structure of the present invention;

FIG. 2 is a schematic diagram illustrating an exemplary structure of the cutter head assembly of the present invention;

FIG. 3 is a schematic diagram illustrating the assembled structure of the external-rotor motor, eccentric wheel and bearing of the present invention; and

FIG. 4 is a schematic diagram illustrating the disassembled structure of the external-rotor motor, eccentric wheel, bearing, mounting bracket and sealing ring of the present invention.

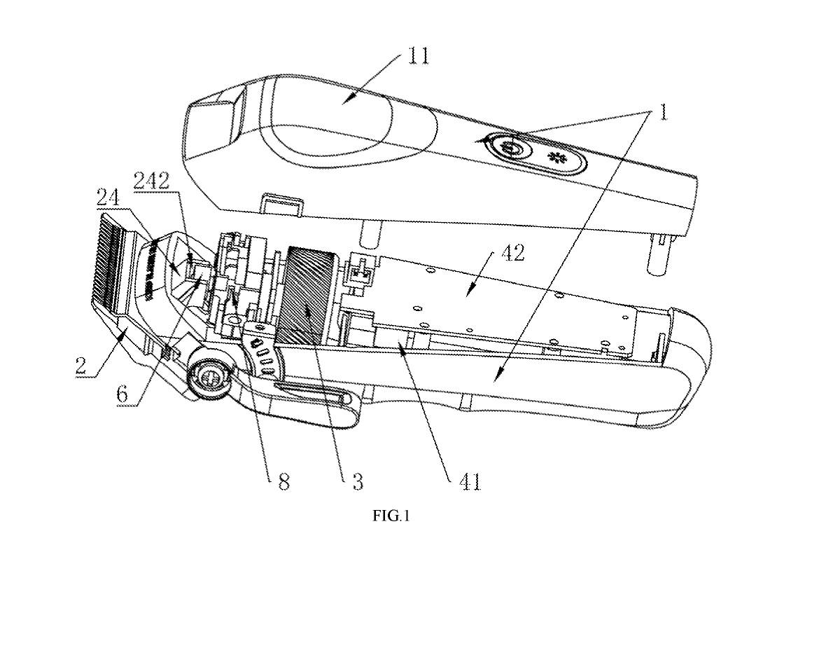

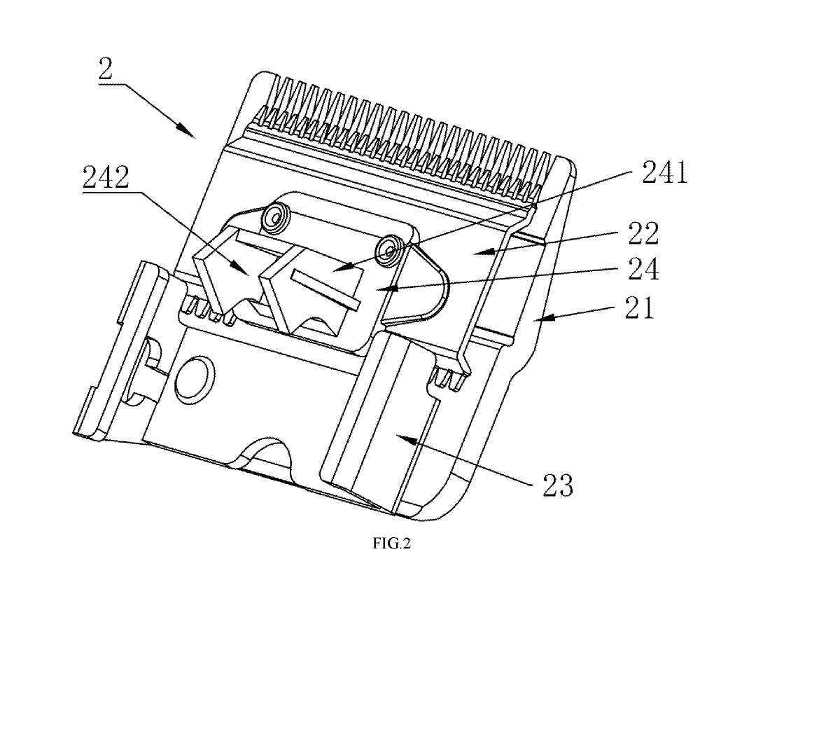

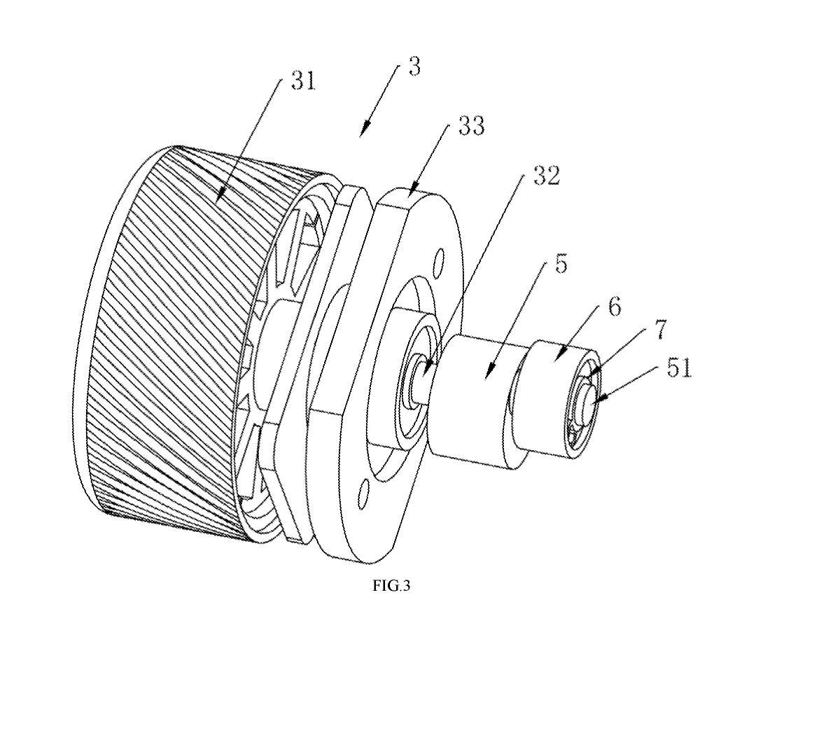

In FIGS. 1-4: 1-Housing, 11-Window, 2-Cutter Head Assembly, 21-Fixed Blade, 22-Movable Blade, 23-Fixed Cutter Holder, 24-Movable Cutter Holder, 241-Convex Platform, 242-Transmission Groove, 3-External-rotor Motor, 31-Rotor, 32-Output Shaft, 33-Motor Fixing Frame, 41-Power Supply Assembly, 42-Control Circuit Board, 5-Eccentric Wheel, 51-Eccentric Shaft, 52-Eccentric Hole, 6-Bearing, 7-Snap Spring, 8-Mounting Bracket, 81-Avoidance Hole, 9-Sealing Ring.

### DETAILED DESCRIPTION

Drawings are combined hereinafter to further elaborate the technical solution of the present invention.

As shown in FIGS. 1-4, the visual electric hair cutter driven by an external-rotor motor comprises a housing 1, a cutter head assembly 2, an external-rotor motor 3, a power supply assembly 41 and a control circuit board 42. The cutter head assembly 2 is arranged at a front end of the housing 1. The external-rotor motor 3, the power supply assembly 41 and the control circuit board 42 are arranged within the housing 1. The external-rotor motor 3 and the power supply assembly 41 are respectively electrically connected to the control circuit board 42.

The main structure of the cutter head assembly 2 comprises a fixed blade 21, a movable blade 22, a fixed cutter holder 23 and a movable cutter holder 24. The fixed blade 21 is fixedly connected to the fixed cutter holder 23, and the movable blade 22 interacts with the fixed blade 21 in a sliding manner. The movable blade 22 is fixedly connected to the movable cutter holder 24, and the cutter head assembly 2 is mounted at the front end of the housing 1 by means of the fixed cutter holder 23. As an important component of the electric hair cutter, the specific structure and operating principle of the cutter head assembly 2 belong to the prior art, and are therefore not described in detail herein.

As shown in FIG. 1, the housing 1 is at least partially provided with a window 11 for allowing a user to observe the external-rotor motor 3. In this embodiment, to facilitate the observation during use, the window 11 is arranged on an upper surface of the housing 1. More specifically, the window 11 is located in an area of the upper surface of the housing 1 corresponding to the position of the external-rotor motor 3. Definitely, according to actual needs, the window 11 may also be arranged in other areas of the housing 1. In use, the user may observe the operation of the external-rotor motor 3 at any time through the window 11, so that convenient observation of the operating state of the external-rotor motor 3 and better use experience are achieved. In this way, when the motor gets stuck or blocked due to the cut hair entering the interior of the electric hair cutter, the user may timely accurately operates (such as turn-off), which not only facilitates the normal operation of the electric hair cutter, but also prevents the motor from being damaged due to the long-term failure. Thus, the user’s actual needs are satisfied sufficiently.

Preferably, an outer wall of the rotor 31 of the external-rotor motor 3 is provided with a pattern (not shown). When the rotor 31 rotates, the pattern rotating synchronously with the rotor 31 may be observed through the window 11 as well. By means of the pattern on the outer wall of the rotor 31, when in use, clear observation of the operating condition of the external-rotor motor 3 is realized and the appearance of the motor becomes esthetically appealing.

As shown in FIGS. 1, 3 and 4, an output shaft 32 of the external-rotor motor 3 is provided with an eccentric wheel 5, and the eccentric wheel 5 is provided with an eccentric shaft 51. In this embodiment, the eccentric wheel 5 is eccentrically connected to the output shaft 32 of the external-rotor motor 3. More specifically, one end of the eccentric wheel 5 close to the external-rotor motor 3 is provided with an eccentric hole 52, and the output shaft 32 of the external-rotor motor 3 is in interference fit with the eccentric hole 52 of the eccentric wheel 5 in an inserting manner. The eccentric shaft 51 is sleeved with a bearing 6, an end portion of the eccentric shaft 51 is provided with a snap spring 7 for interacting with the bearing 6 in a limiting manner, and the bearing 6 is axially limited between the snap spring 7 and the eccentric wheel 5. By arranging the snap spring 7, the bearing 6 is prevented from falling off from the eccentric shaft 51, thereby achieving an anti-falling effect. Additionally, the eccentric wheel 5 and the bearing 6 may be pre-assembled, so that the assembly efficiency is further improved.

The movable cutter holder 24 of the cutter head assembly 2 is provided with a transmission groove 242, and the bearing 6 extends into the transmission groove 242. Through the interaction between the bearing 6 and the transmission groove 242, the eccentric wheel 5 is in transmission connection with the movable cutter holder 24. The aforesaid transmission structure achieves stable and reliable operating performance. Moreover, because a conventional swing rod is no longer needed, the structure becomes simpler, and the manufacturing cost is reduced. When the external-rotor motor 3 operates, the rotor 31 propels the eccentric wheel 5 to rotate through the output shaft 32, and the eccentric wheel 5 further propels the eccentric shaft 51 and the bearing 6 to eccentrically rotate. Under the interaction of the bearing 6 and the transmission groove 242, the bearing 6 propels the movable blade 22 to linearly swing in a reciprocating manner relative to the fixed blade 21 through the movable cutter holder 24. Thus, the cutter head assembly 2 performs the hair cutting.

In this embodiment, to facilitate the transmission between the movable cutter holder 24 and the bearing 6, the movable cutter holder 24 is provided with a convex platform 241, and the transmission groove 242 is formed in the convex platform 241. Preferably, an outer wall of the bearing 6 is in interference fit with the walls of the two sides of the transmission groove 242, so that the bearing 6 is in interference fit with the walls of the transmission groove 242. In this way, the transmission effect is improved, the operation noise is reduced, and high degree of quietness is achieved.

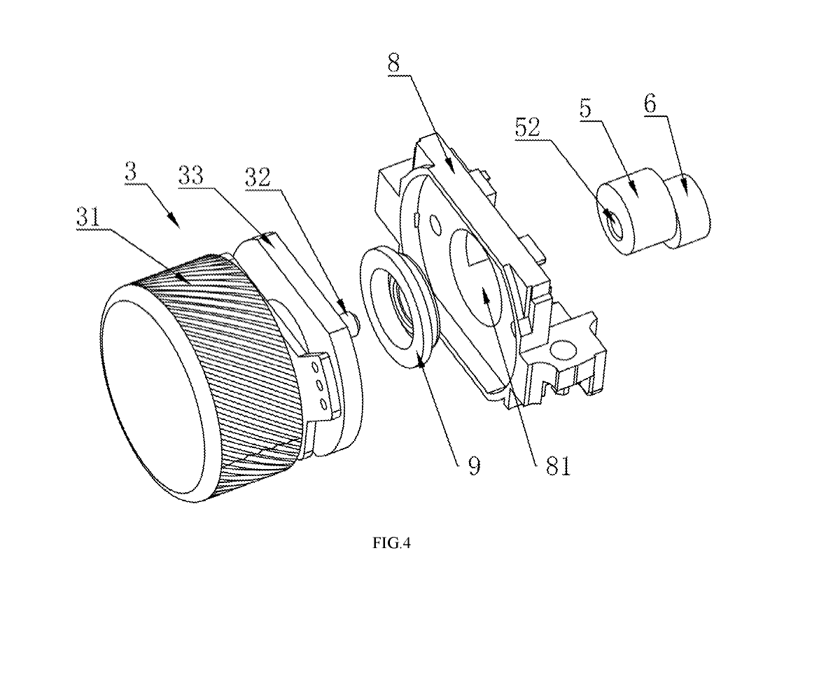

As shown in FIGS. 1 and 4, in this embodiment, a motor fixing frame 33 is arranged at the front end of the external-rotor motor 3, a mounting bracket 8 corresponding to the motor fixing frame 33 is arranged in the housing 1, and the motor fixing frame 33 is fixedly connected to the mounting bracket 8. In this way, the external-rotor motor 3 is fixed in the housing 1. Through arranging the motor fixing frame 33 at the front end of the external-rotor motor 3 and correspondingly arranging the mounting bracket 8 in the housing 1, the mounting structure of the motor becomes simpler and the manufacturing cost is lowered.

Preferably, to ensure the power-transmission effect, the mounting bracket 8 is provided with an avoidance hole 81 for allowing the output shaft 32 of the external-rotor motor 3 to pass through. The avoidance hole 81 is provided with a sealing ring 9 sleeved outside the output shaft 32 of the external-rotor motor 3. By means of the sealing ring 9, the effect of preventing hair from entering is achieved, and the operating performance of the electric hair cutter is enhanced.

The above are merely preferred embodiments of the present invention, and therefore, equivalent changes or modifications made according to the structure, feature and principle of the present invention shall fall into the scope defined by the claims of the present invention.

What is claimed is:

1. A visual electric hair cutter driven by an external-rotor motor, comprising:
a housing (1),
a cutter head assembly (2), and
an external-rotor motor (3), wherein the cutter head assembly (2) is arranged at a front end of the housing (1), wherein the external-rotor motor (3) is arranged within the housing (1), wherein the housing (1) is at least partially provided with a window (11) for observing the external-rotor motor (3), wherein an output shaft (32) of the external-rotor motor (3) is provided with an eccentric wheel (5), wherein the eccentric wheel (5) is provided with an eccentric shaft (51), wherein the eccentric shaft (51) is sleeved with a bearing (6), wherein the movable cutter holder (24) of the cutter head assembly (2) is provided with a transmission groove (242), wherein the bearing (6) extends into the transmission groove (242), and wherein through the interaction between the bearing (6) and the transmission groove (242), the eccentric wheel (5) is in transmission connection with the movable cutter holder (24).

2. The visual electric hair cutter driven by an external-rotor motor of claim 1,
wherein the window (11) is arranged on an upper surface of the housing (1).

3. The visual electric hair cutter driven by an external-rotor motor of claim 1,
wherein an outer wall of the rotor (31) of the external-rotor motor (3) is provided with a pattern, and wherein when the rotor (31) rotates, the pattern rotating synchronously with the rotor (31) can be observed through the window 11.

4. The visual electric hair cutter driven by an external-rotor motor of claim 1,
wherein the movable cutter holder (24) is provided with a convex platform (241), and wherein the transmission groove (242) is formed in the convex platform (241).

5. The visual electric hair cutter driven by an external-rotor motor of claim 1,
wherein an outer wall of the bearing (6) is in interference fit with the walls of the two sides of the transmission groove (242).

6. The visual electric hair cutter driven by an external-rotor motor of claim 4,
wherein an outer wall of the bearing (6) is in interference fit with the walls of the two sides of the transmission groove (242).

7. The visual electric hair cutter driven by an external-rotor motor of claim 1,
wherein a motor fixing frame (33) is arranged at the front end of the external-rotor motor (3), wherein a mounting bracket (8) corresponding to the motor fixing frame (33) is arranged in the housing (1), and wherein the motor fixing frame (33) is fixedly connected to the mounting bracket (8).

8. The visual electric hair cutter driven by an external-rotor motor of claim 6,
wherein the mounting bracket (8) is provided with an avoidance hole (81) for allowing the output shaft (32) of the external-rotor motor (3) to pass through.

9. The visual electric hair cutter driven by an external-rotor motor of claim 7,
wherein the avoidance hole (81) is provided with a sealing ring (9) sleeved outside the output shaft (32) of the external-rotor motor (3).

10. The visual electric hair cutter driven by an external-rotor motor of claim 1,
wherein the eccentric wheel (5) is eccentrically connected to the output shaft (32) of the external-rotor motor (3).

11. The visual electric hair cutter driven by an external-rotor motor of claim 1,
wherein an end portion of the eccentric shaft (51) is provided with a snap spring (7) for interacting with the bearing (6) in a limiting manner.
